(19) United States
(12) Patent Application Publication
(10) Pub. No.: US 2012/0127605 A1
(43) Pub. Date: May 24, 2012

(54) METHOD AND DEVICE FOR MAPPING THE MAGNETIC FIELD OR MAGNETIC FIELD SENSITIVITY OF A RECORDING HEAD

(75) Inventors: Nicholas J. GRANGER-BROWN, Waterlooville (GB); Graham R. Eveleigh, Rake (GB); Michael P. Cooke, Hook (GB)

(73) Assignee: Xyratex Technology Limited, Havant (GB)

(21) Appl. No.: 13/296,850

(22) Filed: Nov. 15, 2011

Related U.S. Application Data
(60) Provisional application No. 61/415,223, filed on Nov. 18, 2010.

(51) Int. Cl. G11B 5/455; G11B 5/127

(52) U.S. Cl. 360/75; G9B/5.145; G9B/5.04

(57) ABSTRACT

A method and apparatus for scanning a read/write head of a hard disk drive during manufacture are presented. The method includes: providing a magnetic sensor; moving the magnetic sensor relative to and in close proximity to the read/write head under test; obtaining measurements from the head under test or the sensor, representing a two-dimensional magnetic map; processing the map to obtain an accurate map of the head sensitivity of the head under test from which the key performance characteristics of the head can be obtained.

### CROSS REFERENCE TO RELATED APPLICATIONS

This application claims priority to U.S. Provisional Application No. 61/415,223, filed Nov. 18, 2010. The content of this application is incorporated herein by reference in their entirety.

The present invention relates to a method and device for mapping the magnetic field or magnetic field sensitivity of a recording head. The recording head may be either a read or a write head. Typically, the recoding head is a magnetic recording head that can be controlled both to write and to read data to or from a magnetic storage medium.

A hard disk drive typically includes a storage medium together with a recording head for writing data to and/or reading data from the storage medium. The head typically operates by control of a magnetic field generated (in write mode) or sensed (in read mode) by the head. The magnetic field or magnetic field sensitivity of a recording head is an important factor in the quality of a data storage device such as a hard disk drive. Indeed, having an understanding and knowledge of the magnetic field generated by a head is important so as to be able accurately to control and operate a hard disk drive whilst minimising read and/or write errors.

There are a number of known methods of measuring and characterising the read and write magnetic fields of a hard disk drive recording head. In some embodiments, a spinstand is used to measure performance in key areas and in others an atomic force microscope or other fine probe is used to detect or “read” the magnetic field of the head on a small scale. Although these methods can work and provide a reasonable map of the magnetic field or magnetic field sensitivity of a recording head, they can be very slow. Accordingly they are expensive to use and can be impractical for use during manufacture of a disk drive when quick and efficient operation is required. Furthermore, these known methods are generally impractical for use with recording heads at the ROW/BAR level, i.e. when there are 40 to 50 heads together in one unit. Indeed, use of a spin stand relies on the recording heads being singular. This is a major disadvantage.

In the article entitled “Recording Head Characterisation Using A Narrow Domain Wall In Epitaxial Garnet Films” by J. Heidmann and A. Taratorin, published in IEEE Transactions on Magnetics, Vol. 45, Issue 10, October 2009, pages 3652 to 3655, there is disclosed a method for recording head characterisation that uses a domain wall in a ferromagnetic garnet film with high perpendicular anisotropy as a highly localised field source with nanometre extent. As explained, when the domain wall is moved cross track over the read sensor of a perpendicular recording head, the spatial response function of the sensor is measured.

From the response curve, the magnetic read width of the sensor can be calculated and details of the response can reveal local sensor instabilities. By oscillating the domain wall at a frequency of a few megahertz, the method can also be applied to write-head testing when the write pole is subjected to the field from the oscillating domain wall and the induced voltage in the write coil is measured. However this is an expensive and time-consuming process which is not suited for use in high volume manufacturing processes.

In the article entitled “Iterative Image Restoration Using Approximate Inverse Preconditioning” by Nagy et al published in IEEE Transactions on Image Processing, Vol. 5, No. 7, Pages 1151 to 1162, July 1996, there is disclosed a method by which a linear shift-variant blur is removed from a signal or image by inverse or Wiener filtering or by use of an iterative least-squares de-blurring procedure. The method disclosed concerns solving de-convolution problems for atmospherically blurred images by the preconditioned conjugate gradient algorithm, where a new approximate inverse preconditioner is used to increase the rate of convergence.

Other known methods for imaging read and write heads are disclosed in US-A-2007/0197911 (Kaiser) and US-A-2005/0276512 (Atkinson).

In Kaiser, there is disclosed a method for resolving features on a probe array that comprises acquiring a plurality of micro-shifted images of a region of a probe array, reconstructing an image of the probe array using the micro-shifted images; and deriving intensity values for one or more probe features disclosed on the probe array from the reconstructed image.

In Atkinson, there is disclosed a method and system for the selective use of de-convolution to reduce crosstalk between features of an image. Initially, areas of an image for de-convolution are selected. An image is provided comprising a plurality of features, wherein each feature is associated with at least one value (v). A test feature is identified with a high-value feature adjacent to a known low-value zone of the image. The method comprises the step of de-convolving the selected areas of the image.

In general then it can be understood that what is desired is a method and apparatus for mapping the magnetic field of a magnetic recording head that can work in a quick and efficient manner and is suitable for use in a test process during manufacture of a hard disk drive.

According to a first aspect of the present invention, there is provided a method of determining a map of the magnetic field or field sensitivity of the recording head for a hard disk drive, the method comprising: providing a magnetic sensor; moving the magnetic sensor relative to and in close proximity to the recording head under test; obtaining measurements from the recording head under test or the sensor to produce a two-dimensional image representative of the recording head; processing the two-dimensional image to obtain a map of the magnetic field or field sensitivity of the recording head under test.

Thus, the invention provides a simple and robust way by which a magnetic field or magnetic field sensitivity of a magnetic recording head can be determined. The method is quick and efficient and preferably the determination of the map can be achieved in less than 10 s, thus making the method suitable for use during manufacture of a hard disk drive. As explained below, it will be appreciated, that the terms “sensor” and “recording head” as used herein will be construed appropriately such that the sensor itself can be thought of as a recording head and vice versa. It will also be appreciated that what is important is that there is relative movement between the sensor and the recording head such that a scan of the head can be made. The head can be kept stationary whilst the sensor is moved or vice versa. Indeed in some embodiments both the head and the sensor can be controlled to moved during a scan.

In one embodiment, the method comprises processing the map to predict the key performance characteristics of the head. In other words, the map is used to enable key performance characteristics of the recording heard under test to be predicted.

In one embodiment, the head under test is a read head. In another embodiment, the head under test is a write head.

In one embodiment, the method comprises controlling relative movement of the sensor and the head under test using two degrees of motion.

In one embodiment, the processing of the map comprises de-convolving the map so as to obtain a resultant two-dimensional magnetic map.

In one embodiment, the de-convolving is performed using a Richardson-Lucy blind de-convolution algorithm Thus, the processing of the image can be performed without any prior knowledge of the spatial sensitivity of the sensor.

According to a second aspect of the present invention, there is provided a system for generating a magnetic map of a read/write head for a magnetic storage medium, the system comprising: a test sensor for controlled movement relative to a head under test, the test sensor being arranged to detect or generate a test magnetic field; a position controller for controlling the position of the test sensor relative to the said read/write head under test; a processor for generating signals for provision to and receiving signals from the test sensor and the head under test and obtaining measurements from the head under test or the sensor to produce a two-dimensional image representative of a parameter of the head and to process the image so as to determine a two-dimensional magnetic map of the head under test.

In one embodiment, the sensor is arranged to move whilst the head under test remains stationary.

In one embodiment, the head comprises a pole tip shaped so as to provide an accurate magnetic map.

In one embodiment, the sensor comprises plural pole tips.

In one embodiment, the pole tips have different shapes.

In one embodiment, the pole tips are one or more of triangular, rectangular, square, trapezoidal and L-shaped.

In one embodiment, relative movement of the sensor with respect to the head under test is controlled using two control systems including both a coarse control system and an accurate control system.

In one embodiment, the movement of the sensor is along a defined trajectory which is selected from the group including spiral movement and side to side translational movement.

In one embodiment, the angle of the sensor is varied during testing so as to enable an accurate determination of the magnetic map.

According to a third aspect of the present invention, there is provided a method of making a hard disk drive, the method comprising: providing a recording head for a hard disk drive; and, scanning the recording head during manufacture using a method according to the first aspect of the present invention.

It will be appreciated that during manufacture of a hard disk drive, many steps are required both of manufacture and assembly. In addition, the present invention, in this aspect, comprises during manufacture or assembly of a hard disk drive, the process of scanning the recording head to determine its magnetic field or magnetic field sensitivity. The process of scanning is quick enough and efficient enough to be used during the normal process of manufacture and assembly of the hard disk drive which means that this important test can easily and conveniently be introduced to the manufacture or assembly process.

Typically, early in the manufacturing process for the heads after the head dimensions have been defined but before high cost operations such as suspension attachment have been performed, a magnetic sensor is moved relative to and in close proximity to the recording head under test; measurements are obtained from the recording head under test or the sensor to produce a two-dimensional image representative of the recording head, which is then processed to obtain a map of the magnetic field or field sensitivity of the recording head under test. This is then used to determine the quality of the head and whether it is to be processed further.

According to a fifth aspect of the present invention, there is provided a method of generating a sensor sensitivity map for a magnetic sensor for use in the mapping of the magnetic field or magnetic field sensitivity of a magnetic recording head, the method comprising: providing a recording head with a known magnetic field or magnetic field sensitivity, scanning the recording head with a magnetic sensor having an unknown sensitivity map; generating an image by said scanning; from said image and the known magnetic field or magnetic field sensitivity of the recording head determining the sensor sensitivity map for a magnetic sensor.

According to a sixth aspect of the present invention, there is provided a test system for generating a magnetic map of a head under test, the system comprising: a position controller for accurately controlling the position of a test sensor relative to a head under test; a processor for generating and receiving signals so as to determine a two-dimensional magnetic map of the head under test.

Embodiments of the present invention will now be described in detail with reference to the accompanying drawings, in which:

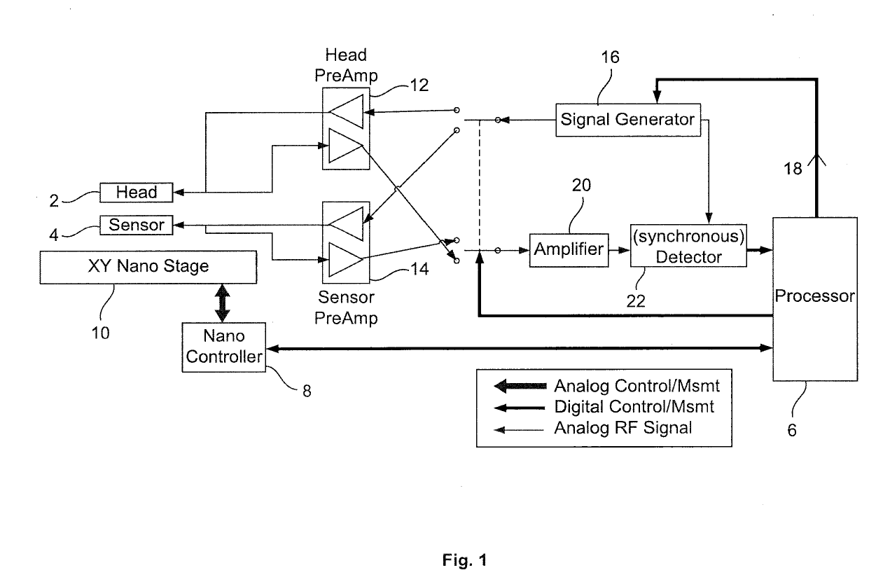

FIG. 1 is a schematic representation of a scanning system;

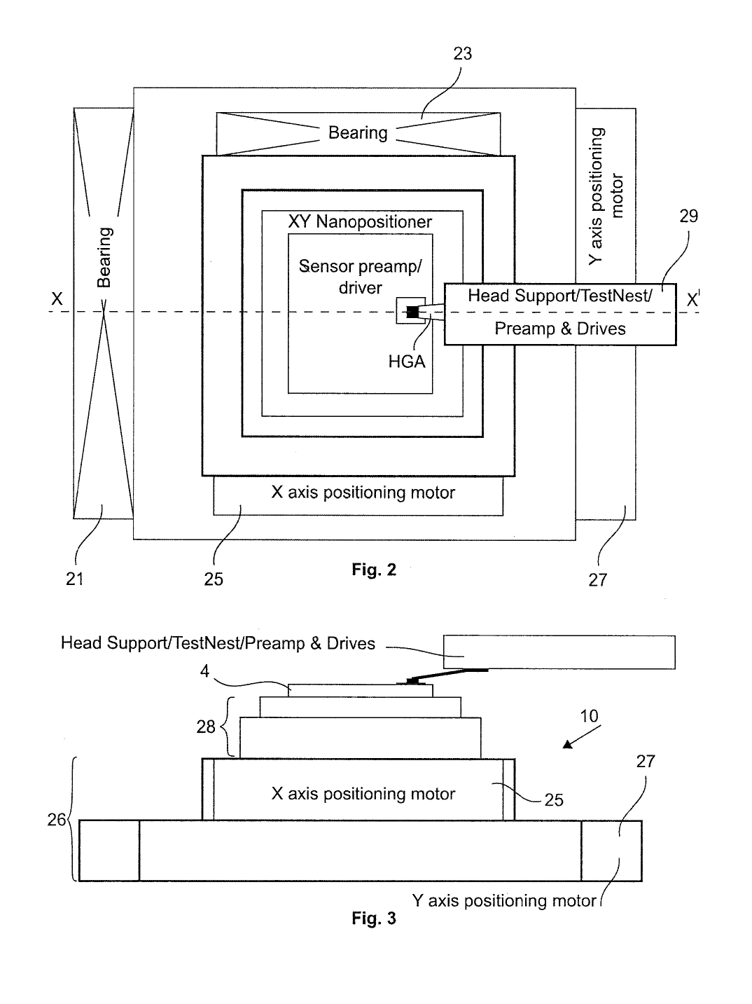

FIG. 2 is a schematic representation of a plan view of a scanning system;

FIG. 3 is a view of a vertical section along the line X-X′ in FIG. 2;

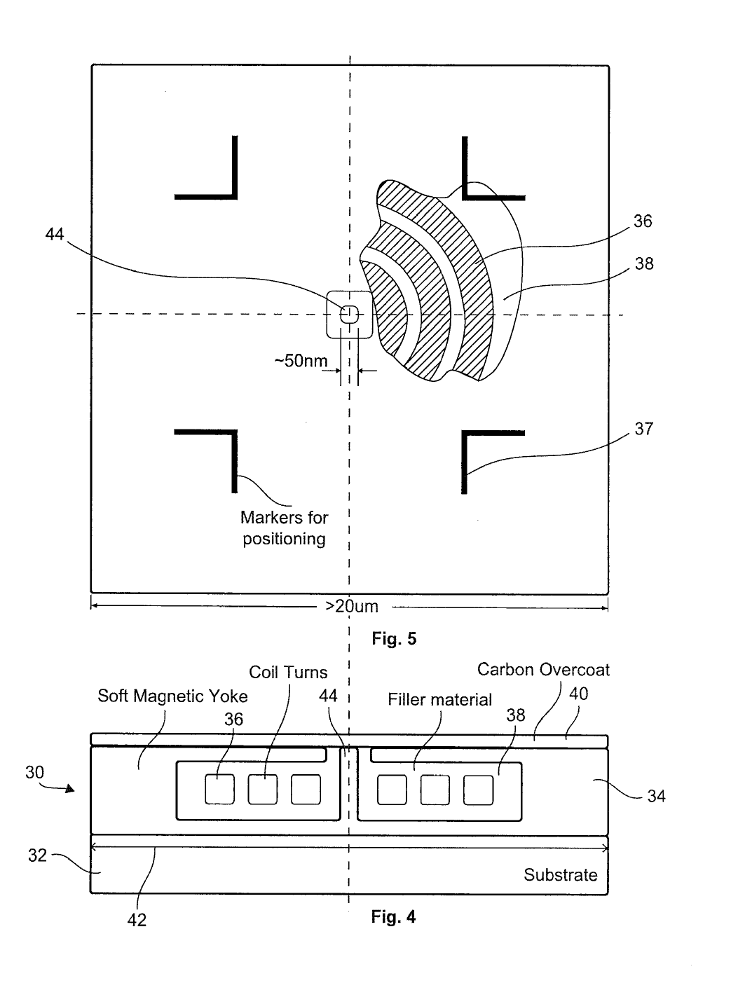

FIG. 4 is a vertical section through a sensor for use in the apparatus of FIGS. 2 and 3;

FIG. 5 is a plan view of the sensor of FIG. 4;

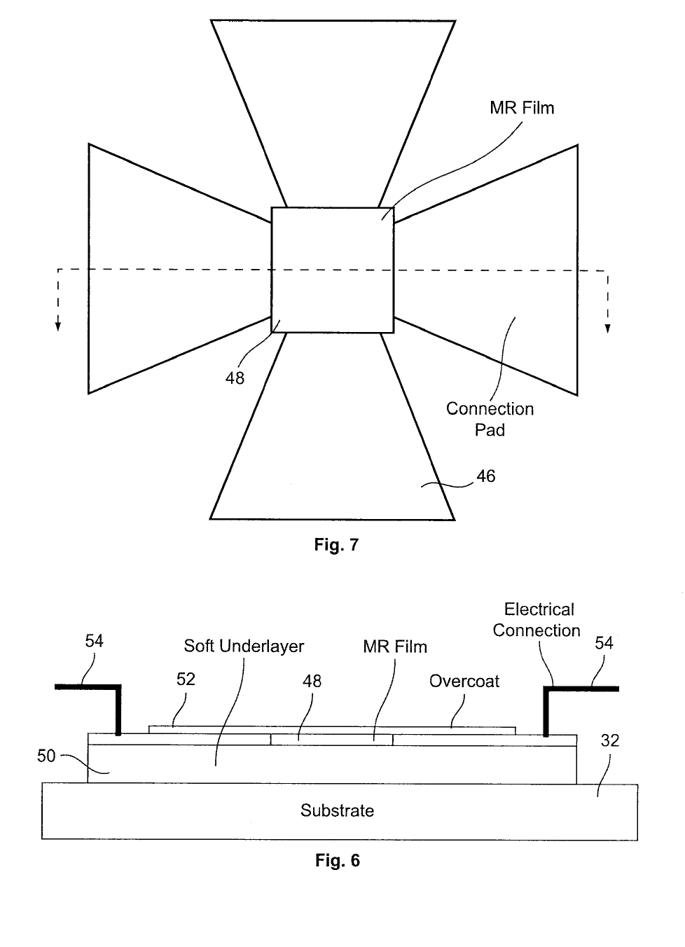

FIGS. 6 and 7 show, respectively, a vertical section through and a plan view of an alternative embodiment of a sensor;

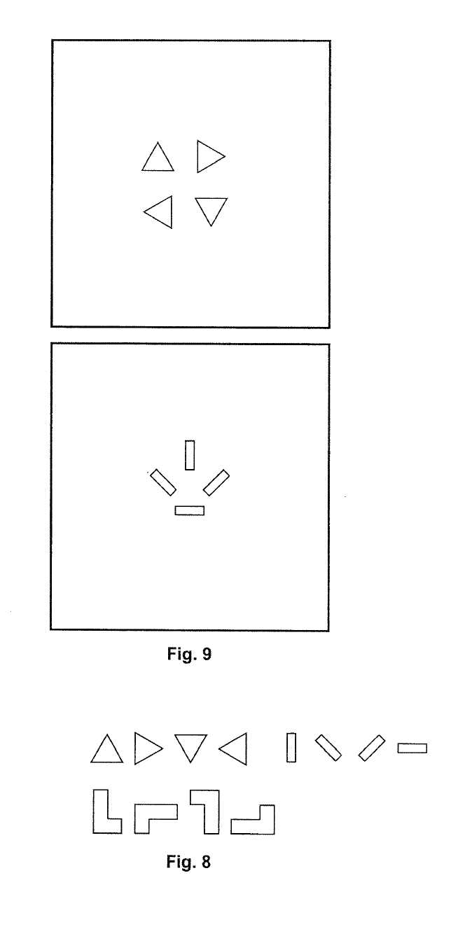

FIG. 8 is a schematic representation of various pole tip shapes;

FIG. 9 is a schematic representation of a sensor with plural pole tips;

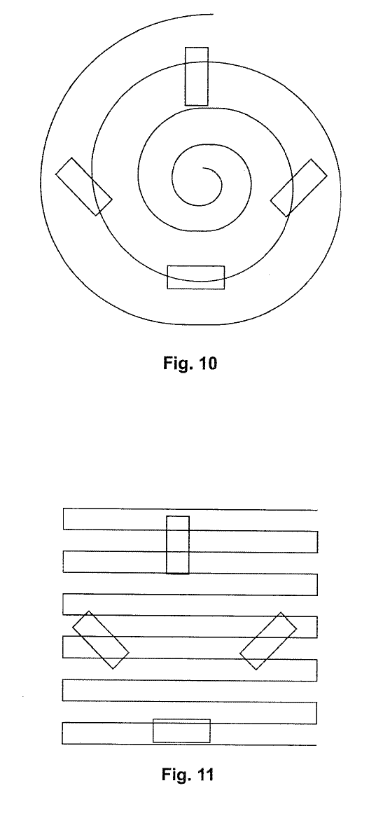

FIGS. 10 to 13 show schematic representations of various pole tips and scanning trajectories.

FIG. 1 shows a schematic representation of a measurement system. The measurement system is for mapping the magnetic field or magnetic field sensitivity of a recording head 2 under test which may be a recording head that is from or forms part of a hard disk drive. In other words, the type of head for which the measurement system is typically provided for use, is a HDD read/write head. In general, the measurement system serves to generate a map of the magnetic field or magnetic field sensitivity of a recording head.

As will be explained below, the measurement system is able to provide an accurate representation of a 2 dimensional magnetic field map in a quick and efficient manner such that the system is suitable for use in the testing of HDD heads during manufacture of HDDs. This is extremely useful since the system does not suffer from the problems mentioned above with respect to the available prior art, i.e. high cost and complexity and the long duration of a test.

In more detail now, the measurement system comprises a sensor 4 movable under control of a processor 6. The sensor is moveable close to the recording head under test. In other words it is moved close enough so that the magnetic field of the sensor can be detected by the head and vice versa. Typically, the sensor might actually be in contact with the recording head during a test. In some cases a small separation might be present such as between 0 nanometres and 20 nanometres determined in part by the design of the head being tested. In some examples, in use, the sensor is held stationary and the recording head is moved. What is important is that there is relative movement of the sensor with respect to the recording head.

A nanocontroller 8 is provided in communication with the processor 6 and is for providing nanocontrol of the movement of the sensor 4 via, what is labelled, a “nanostage” 10. The nanocontroller 8 is arranged to receive signals from the processor 6 and provide control signals to the nanostage 10 so as to cause the sensor 4 to move in a desired manner and on a very small scale. Such accurate and precise control of the small scale movement of the sensor is required to enable the sensor to generate the data needed to produce an image of the magnetic field or magnetic field sensitivity of the head under test.

As will be explained below, the nanostage 10 is preferably the second movement control mechanism. The first serves to locate the sensor in the right general area for testing, such that the second, the nanostage 10, can then be used for the accurate XY position control of the sensor 4. This has the benefit that the nanostage 10 does not need to be able to move the sensor over large distances, but only over the small distances needed for the relative movement between the sensor and head in performance of a measurement or scan.

Two preamplifiers 12 and 14 are provided. First, a test head preamplifier 12 is arranged to provide signals to and receive signals from the head 2 under test. Second, a sensor preamplifier 14 is arranged to receive signals from and provide signals to the sensor 4.

A signal generator 16 is provided in communication with the processor 6. In use, the processor 6 generates control signals that are provided to the signal generator 16. Typically the signal provided to the signal generator from the processor is a digital control signal. The signal generator 16 in turn provides drive signals, via the preamplifiers 12 and 14 to the head 2 and sensor 4. Typically, the drive signals are analog RF signals.

Whilst the drive signals are being provided by the signal generator 16, control signals, e.g. digital control signals, are provided to the nanocontroller 8 and subsequently to the nanostage 10 so as to ensure that the sensor 4 is moved in a known manner to correspond to the signals provided by the signal generator 16. It will be appreciated that for the signal generator 16 and the pre-amplifiers 12 and 14, off-the-shelf components may be used. They may be implemented in hardware, e.g. an ASIC, FPGA, or commercial instrumentation or as software running on a processor.

An amplifier 20 is provided together with a synchronous detector 22 to route signals back to the processor 6 from the preamplifiers 12 and 14. Thus, as signals are provided by the preamplifiers 12 and 14, they are routed to the amplifier 20 and from there back to the processor 6 for further processing. A reference signal 24 is provided by the signal generator 16 for the synchronous detector 22. The synchronous detector (sometimes referred to as a “Lockin Amplifier”) uses the reference signal 24 from the original signal source in order to separate the sensor signal from the noise.

Operation of the system will be described in detail below. However, for now, in general it will be understood that the system can be used to map the magnetic field or magnetic field sensitivity of a recording head which can be a read and/or a write head. In the case of a write head, the test head 2 is provided with signals via the signal generator 16 and preamplifier 12. The signals are detected by the sensor 4 which generates output signals in dependence on the magnetic field it detects and provides the output signals to the preamplifier 14. From there, the output signals are transferred to the processor via the amplifier 20 and detector 22. The signals may then be processed, as will be explained below, to generate a map of the write head field for the head 2.

When operating so as to characterise the magnetic field sensitivity of a read head, the recording head under test would be the “sensor”, i.e. it would serve to detect magnetic fields generated by the actual sensor 4. The function of the sensor 4 itself is reversed so as to provide a magnetic field, rather than to detect one, and the mapping process is then performed in the substantially same way.

In greater detail, when the magnetic field of a write head (a recording head operating in write mode) is to be mapped, the sensor 4 is scanned across the write head, or vice versa, in X and Y directions. Whilst the scanning is happening, the write element of the head is excited at an RF frequency as if writing to a disk. As the sensor 4 scans in the X and Y directions relative to the head 2, at each point along its scan, it picks up a magnetic signal, i.e. detects the varying magnetic field, from the write element of the head 2 excited at the RF frequency. The sensor 4 generates an output signal which is provided to the preamplifier 14 and amplifier 20 for amplification. The signal is preferably then filtered and a narrow band measurement made. Next, a two-dimensional image is generated of the signal strength versus the XY position. In other words, at each selected XY position a reading is made so that a two-dimensional scanned image is thus built up during a scan.

Once a two-dimensional scanned image has been obtained in this way, the write head magnetic field of the head under test is then extracted by de-convolving the two-dimensional scanned image from the spatial sensitivity of the sensor 4. This will be explained in more detail below.

In terms of dimensions, typically, a normal write head map would be approximately 200 nanometres by 200 nanometres with a resolution of between 2 and 5 nanometres. The same method could also be used to map the characteristic magnetic field of the write head return pole.

The relative positions of the sensor 4 and the head 2 under test must be known so as to enable a scan to be performed. Accordingly, the XY nanostage 10 is used to ensure accurate positioning of the sensor 4 relative to the head 2 and small scale movement of the sensor 4 relative to the head. FIG. 2 shows a schematic representation of a positioning system that would typically be used. In an embodiment, a support arm 29 is typically provided as part of the test assembly to support a recording head under test. This can be any appropriate type of support mechanism.

To enable precise alignment between the recording head under test and the sensor, typically two movement stages or systems are provided. A coarse positioning system is provided capable of resolution to within, say, 100 nanometres, but able to move over a relatively large distance, i.e. several millimetres. In addition, a final stage positioning system (the nanostage 10) is provided, capable of movement to accuracy within less than 1.0 nanometres. The final stage positioning system would typically be provided arranged on the coarse positioning system. In use, first the coarse positioning system is controlled so as to bring the sensor within the right general area for a scan of the recording head under test. Then, once in this position, the final stage positioning system may be controlled to move the sensor accurately along its scan trajectory.

The signals that will be provided by the sensor 4 as it scans across the write head under test 2, will typically be small but are accurately measured, e.g. preferably to within 1% accuracy. To achieve this, a narrow band spectrum analyser is used together with integration (averaging) over a suitable time period. Alternatively, synchronous detection with a lock-in amplifier may be used.

Prior to use of the system, the spatial sensitivity of the sensor 4 is preferably accurately mapped, so as to enable a subsequent de-convolution to take place. In other words a calibration map of the sensor is provided prior to the actual scanning of a recording head. This mapping of the spatial sensitivity of the sensor 4 only needs to be done once so that the spatial sensitivity of the sensor 4 is known. Typically, atomic force microscopy, i.e. an extremely accurate method of mapping, is used to map the spatial sensitivity of the sensor so as to provide the calibration map. Once this has been done, the sensor can be used as desired. In an alternative, instead of using atomic force microscopy, or any other such method of mapping of the sensor sensitivity, initial measurements with a sensor can be made of a previously characterised, i.e. mapped, recording head which will thus enable the sensor sensitivity to be determined

Alternatively, if it is desired blind de-convolution may be used using the Richardson-Lucy algorithm or similar without prior knowledge of the sensor sensitivity.

Referring now to FIGS. 2 and 3, a system for controlling the position of the sensor 4 during operation will now be described. As mentioned above, two positioning systems are provided, which are preferably independently controlled. A coarse positioning system 26 is provided together with an accurate or final stage positioning system 28 arranged thereon. The sensor 4 is provided on the final stage positioning system 28 or XY nanostage 10. Thus, the coarse positioning system 26 can be used to bring the sensor 4 to within the approximately correct position for sensing and then accurate control of the sensor, i.e. for scanning itself, is performed by the XY nanostage 10.

Any suitable form of bearings and control mechanism can be used. In the non-limiting example shown, two motors are provided, for each of the systems 26 and 28. In other words, for the coarse positioning system 26 an x-axis positioning motor 25 and a y-axis positioning motor 27 are provided for controlling movement of the system on bearings 23 and 21, respectively. Motors are also provided for control and operation of the final stage positioning system 28. Whilst in some embodiments there is provided both a coarse XY positioning system and a fine XY positioning system which are separate, in some embodiments this is not the case. Indeed, in some embodiments, there is only a single positioning system which can accomplish both the range of movement of the coarse system and the resolution of the fine system.

FIG. 4 shows a schematic representation of a section through an example of a sensor 4. The sensor comprises a main body 30 and a substrate 32. Formed on the substrate 32, is a magnetic sensor mechanism including a soft magnetic yoke 34 together with plural turns 36 of a coil. A filler material 38 is provided and surrounds the coil turns 36. A surface layer 40 is provided on top of the sensor. The surface layer 40 is preferably textured so as to ensure that the head under test and the sensor do not stick to each other. A controlled roughness or texture provided on the surface 40 ensures that the sensor will not stick to the head. In one embodiment, the surface of the sensor is provided with a Surface Wave Transducer (SWT) which serves to generate moving waves or ripples in the surface of the sensor and thus ensures that, in use, it does not stick to the recording head under test.

In another embodiment, the surface of the sensor may be patterned using the method for laser patterning of surfaces disclosed by U.S. Pat. No. 5,567,404. The process disclosed is for creating an array of bumps to texture a brittle non-metallic surface such as a glass substrate for data recording disks. The texturing process uses a laser to provide pulses of energy to the brittle glass surface so as to produce a plurality of raised bumps in the surface. The bump creation is accomplished without unwanted micro-cracking or rejection of surface material, by limiting the laser pulse fluence to a value in a narrow operating region below the abrupt thermal shock fluence threshold for the brittle non-metallic surface material.

The width 42 of the sensor is typically about 20 micrometres, but may be anything from about 10 micrometres to about 50 micrometres. The pole tip 44 typically has dimensions of approximately 50 nanometres, but may be anything from about 30 nanometres to about 200 nanometres. The typical pole tip dimensions of approximately 50 nanometres are at the extreme of current lithography capability and in some examples the pole tip dimensions may be greater, e.g. up to 100 or 200 nanometres and will still function perfectly well. The shape of the pole tip can be any suitable shape and this is discussed in greater detail below. The examples of the dimensions of the sensor given herein are of course not limiting.

Any suitable materials may be used for the substrate 32, the surface layer 40, the magnetic yoke 34, the filler materials 38 and coils. Typically, the substrate may be a ceramic material such as a dual phase ceramic of alumina and titanium carbide, commonly know as AlTiC In some examples, the substrate is formed of silicon or a metal plate. The sensor is itself, in effect, a thin film magnetic read/write recording head which may be produced by deposition and etching of various layers such that it appears to a PMR recording head as the surface of a HDD with a point source of magnetism.

The sensor preferably also has included on it one or more alignment features 37. The alignment features 37 are provided so as to enable the sensor and the recording head under test to be brought into the right general relative positions for a scan. Indeed, the use of such features enable a quick and efficient alignment of the sensor with the recording head under test. In the example shown, the features 37 comprise optical marking etched onto the surface of the sensor. In such a case an optical microscope would be provided as part of the test assembly. When the sensor was brought to within the vicinity of the recording head under test the optical microscope is used automatically, or manually, to guide the sensor to be in the correct general area. Some means of feedback between the microscope and the coarse XY positioning system is provided (and possibly the fine XY positioning system too) such that upon detection of the alignment features 37 by the microscope a corresponding control signal can be sent to the coarse XY positioning system.

In another embodiment, magnetic structures such as further or additional coils are provided around the sensor. The further or additional coils are structured and arranged such that, when energised with an AC power source, a magnetic field is generated having a null region in the vicinity of the sensor pole tip(s). A magnetic detector is provided as part of the test assembly such that when the sensor is first brought to within the vicinity of the recording head under test, the magnetic detector is used automatically, or manually, to guide the sensor to be in the correct general area. In other words the magnetic detector works in an analogous manner to the optical microscope in the example described above. Any other suitable form of alignment feature could be used. Furthermore, the features could be provided on the assembly holding the head under test instead of or as well as being provided on the sensor. For example, the alignment feature(s) could be provided as part of the support arm 29. In this case the detection mechanism would be provided as part of the sensor.

FIGS. 6 and 7 show an alternative embodiment. In this example, again, a sensor is provided formed on a substrate 32. The sensor comprises plural connection pads 46, each in connection with a magneto resistive (MR) film 48. The MR film may be formed of any appropriate material(s). Non-limiting examples include N-doped germanium, silver Telluride, thin magnetic films of perovskite and similar materials (complexes of Calcium Manganese and Oxygen with other elements). A soft under layer 50 is provided and a protective overcoat 52 is formed above the MR film 48. The overcoat may be formed of any appropriate material. One non-limiting example is Diamond Like carbon (DLC). Electrical connections 54 are provided. The sensor of FIGS. 6 and 7 is capable of mapping, but not of generating a magnetic field. Accordingly, such a sensor can only be used to measure the write head field and not to test the magnetic field sensitivity of a read head. The sensor relies on a bulk property of the medium such as an MR resistance or the Hall effect to sense the magnetic field of the head under test. The means by which the sensor is used is effectively the same as that described above with reference to any of FIGS. 1 to 5. In other words, the sensor is moved relative to the recording head under test and a map of the magnetic field generated by the write head may thus be determined.

It will be appreciated that other forms of sensor may be used. What is required is a sensor that is able to be moved in a precise controlled manner relative to a recording head under test and that is able to pick up, detect or generate magnetic fields of the order of magnitude which would be detectable or produced by a HDD recording head to be tested.

As explained above, due to the fact that the sensor has some surface area, i.e. is not a singularity (in the examples above the pole tip 44 typically, when square, has dimensions of about 50 nm), it is necessary to perform some further processing on the output signal (representing the two-dimensional scanned image) so as to generate an accurate map for the magnetic field or magnetic field sensitivity of a recording head.

Typically, de-convolution is used to provide a magnetic map of the head. In other words, a means is required to enable an accurate 2D map to be generated from the two-dimensional scanned image despite the inevitable “fuzziness” that is a consequence of the finite size of the sensor. One way by which this can be achieved is by a blind de-convolution using an algorithm such as the Richardson-Lucy algorithm. This is well known to the skilled person. A detailed description of the method by which blind de-convolution may be performed is not required. However, a full exposition of this can be found in, for example, D. A. Fish, A. M. Brinicombe, E. R. Pike, and J. G. Walker, “Blind deconvolution by means of the Richardson-Lucy algorithm,” J. Opt. Soc. Am. A 12, 58-65 (1995), the entire contents of which are hereby incorporated by reference.

In embodiments, the sensor is preferably reversible. In other words, it can act both as a magnetic field source and a magnetic field measurement device. As one possible example, the device of FIGS. 4 and 5 can be used as a magnetic field source if currents are provided to the coils or as a magnetic field measurement device if currents generated in the coil due to change in flux of an external magnetic field, are measured. The sensor of FIGS. 4 and 5, and indeed other embodiments, are fabricated as a magnetic coil with a yoke to shield the coil and confine the flux. In addition, in one embodiment, the sensor may be provided with plural coils and poles in close proximity Preferably, each pole is a different shape.

The aim of combining the magnetic maps taken with several sensor shapes or a single sensor in several orientations is to be able to synthesise approximately the map which would have been obtained using a single ideal sensor with a very small pole tip. The ideal sensor is ideal because in the spatial frequency domain, obtained by taking the 2D Fourier transform of the pole shape, every frequency component has the same magnitude and none of them are zero. The real pole tip shapes are chosen such that for every spatial frequency at least one of the sensors has a non-zero component such that when the sensors are combined there are no zero components.

When detecting the write field of a recording head, good noise performance, i.e. a low signal-to-noise ratio (SNR), is preferred. This is particularly the case when a de-convolution is performed as the de-convolution can, in some cases, amplify inaccuracies in the original measurement (the output signal from the sensor during the scan). To achieve a low SNR, a narrowband bandwidth is chosen to give approximately 50 dB SNR assuming a 50 Ohm sensor equivalent noise resistance at room temperature. No amplification noise has been accounted for. The SNR can be improved by reducing bandwidth or averaging the measurement over a longer time.

Referring to FIGS. 8 and 9, examples are given of multiple shaped pole tips and sensors that include plural poles which are shaped accordingly. Each of the poles will include its own separate coil. The use of multiple pole tips, preferably of different shape, and a scanning method so that during a scan of a head, the head passes over each pole tip within the sensor to create multiple two-dimensional scanned images, enables a more accurate result to be achieved, as described above. In particular, the multiple scanned images can be combined to produce a refined two-dimensional scanned image which is, in turn, used to determine the magnetic map or magnetic sensitivity map. In FIG. 9 two examples are shown of multi-pole tip sensors. In the upper figure within FIG. 9 four triangular pole tips are included in the sensor, each of the pole tips being rotated 90 degrees clockwise relative to its nearest anti-clockwise neighbour. Thus, the pole in the top left is triangular with its base horizontally oriented and the triangle extending upwards from the base. The pole tip in the top right corner has its base oriented vertically with the triangle extending to the right, and so on.

In the lower figure within FIG. 9 four rectangular pole tips are included in the sensor. The top centre pole tip is oriented vertically, the bottom centre horizontally. The left and right pole tips are each inclined at an angle of 45 degrees with their respective inner longitudinal ends being lowermost.

FIGS. 10 to 13 show examples of possible trajectories for the sensor. In FIG. 10, the sensor comprises four rectangular shaped pole tips (in the same configuration as the pole tips of the sensor of the upper figure within FIG. 9) and a single spiral trajectory is used. Each of the pole tips of the sensor shown in FIG. 10 may be different shapes, or some may be the same and some different. In FIG. 11, the pole tips are the same as shown in FIG. 11. A side to side scanning motion is used with a climb (or descent) at the end of each crossways scan.

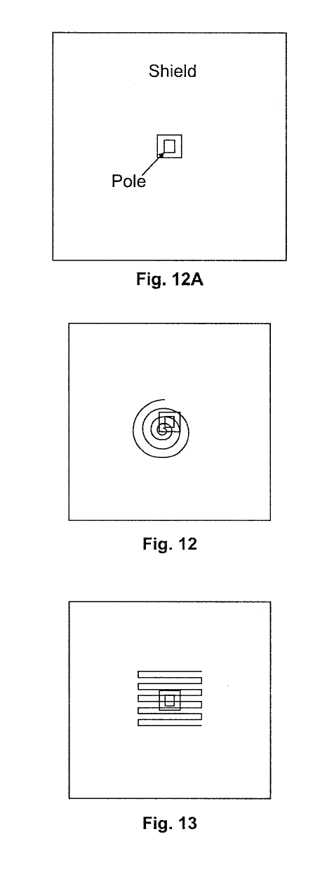

In FIG. 12A a sensor with a single square pole tip is shown. FIGS. 12 and 13 a spiral and side to side scanning technique is used, respectively, similar to those of FIGS. 10 and 11. Other possible scanning trajectories can be used. In one embodiment, a zig zag trajectory is used. It will be appreciated that the scan must cover a 2 dimensional area (the area of the recording head to be scanned) and so where a side to side or zig zag trajectory is used, typically this will be repeated at small displacements across the scan so as to cover the desired scan area.

Preferably, the relative angles of the recording head under test and the sensor is fixed and they are substantially parallel. In other words the plane of the sensor is parallel to the plane of the recording head under test. However, in some embodiments the angle of the sensor is changed so as to obtain a different reading of the field or sensitivity from the recording head. Alternatively, or as well, de-convolution accuracy can be improved if multiple images are taken with the relative angle of the sensor and the head is changed by a known amount between each image. For example, a first image might be generated with the sensor at a “home” position and a second image with the sensor rotated by 90 degrees.

Furthermore, in some embodiments, a head being mapped is scanned two or more times using the same sensor held at different angles and then blind de-convolution is used to determine a most likely head sensitivity without actually knowing the sensor sensitivity shape.

It will be appreciated that in all cases what is being achieved is the mapping of a magnetic recording head magnetic field or magnetic field sensitivity using a magnetic sensor with low spatial resolution such that the resulting map has a high spatial resolution. As compared to spinstand testing or other known methods, referred to above, the present system is faster, more compact and less complex and costly. Indeed, compared with traditional quasi-static testing, the present system is complimentary and could be done on the same fixture giving additional information on head performance.

Compared with current scanning and measurement methods, such as the Heidmann and Taratorin method described in the article “Recording Head Characterisation Using A Narrow Domain Wall In Epitaxial Garnet Films” referred to above, the present method provides a finer resolution, i.e. a better image, in a shorter and quicker time. Thus, a device and method is provided that enables the read and write capability of a magnetic disk drive head to be measured without using an expensive spinstand.

Indeed, using the method and apparatus described herein, it is possible to determine the write field from a writing head such as a PMR (Perpendicular Magnetic Recording) head with 1% amplitude resolution and 2 nm spatial resolution in an extremely short period of time. Typically such a reading or determination might be done in under 10 seconds. This short time scale is quick enough to enable the method to be used as a test during the manufacture process of a HDD. Furthermore, it is also possible to determine the read element near field sensitivity of an MR (Magnetic Recording), GMR (Giant Magnetic Recording) and a TMR (Tunnelling Magnetic Recording) read element sensor with 1% amplitude resolution and 2 nm spatial resolution in the same short period of time, i.e. <10 s.

Embodiments of the present invention have been described with particular reference to the examples illustrated. However, it will be appreciated that variations and modifications may be made to the examples described within the scope of the present invention.

1. A method of determining a map of the magnetic field or field sensitivity of a recording head for a hard disk drive, the method comprising:
providing a magnetic sensor;
moving the magnetic sensor and/or the recording head under test so that the magnetic sensor and the recording head move relative and in close proximity to each other;
obtaining measurements from the recording head under test or the sensor to produce a two-dimensional image representative of the recording head magnetic field or field sensitivity;
processing the two-dimensional image to obtain a map of the magnetic field or field sensitivity of the recording head under test.

2. A method according to claim 1, wherein the recording head under test is a read head, the method comprising generating a field by the sensor for reading by the recording head under test.

3. A method according to claim 1, wherein the recording head under test is a write head, the method comprising generating a field by the head under test for reading by the sensor.

4. A method according to claim 1, comprising controlling relative movement of the sensor and the recording head under test using two degrees of motion.

5. A method according to claim 1, wherein the processing of the two-dimensional image, comprises de-convolving the two-dimensional image so as to obtain a resultant two-dimensional map of the magnetic field of the recording head or the magnetic sensitivity of the recording head.

6. A method according to claim 5, wherein the de-convolving is performed using a Richardson-Lucy blind de-convolution algorithm.

7. A method according to claim 5, comprising:
prior to performing the scan with the sensor, obtaining a map of the spatial sensitivity of the sensor for use when performing the deconvolution.

8. A method according to claim 1, comprising processing the map to predict the key performance characteristics of the head.

9. A method according to claim 1, comprising, prior to performing a scan aligning the sensor with a recording head under test using one or more alignment features provided on the sensor.

10. A system for generating a magnetic map of a recording head for a magnetic storage medium, the system comprising:
a test sensor for controlled movement relative to a recording head under test, the test sensor being arranged to detect or generate a test magnetic field;
a position controller for controlling the position of the test sensor and/or the recording head under test relative to each other;
a processor for generating signals for provision to and receiving signals from the test sensor and the recording head under test and obtaining measurements from the recording head under test or the sensor to produce a two-dimensional image representative of the recording head and to process the image so as to determine a two-dimensional magnetic map of the recording head under test.

11. A system according to claim 10, wherein the sensor is arranged to move whilst the recording head under test remains stationary.

12. A system according to claim 10, wherein the sensor comprises one or more pole tips shaped so as to provide the two-dimensional image representative of the recording head.

13. A system according to claim 12, wherein the processing comprises de convolving the two-dimensional image representative of the recording head with the shape of the pole tip.

14. A system according to claim 12, wherein the sensor comprises plural pole tips.

15. A system according to claim 14, wherein the plural pole tips have different shapes.

16. A system according to claim 10, comprising a coarse positioning system and a final stage positioning system for controlling relative movement of the sensor with respect to the recording head under test.

17. A system according to claim 16, wherein the movement of the sensor is along a defined trajectory which is selected from the group including spiral movement and side to side translational movement.

18. A system according to claim 10, wherein the pole tips are one or more of triangular, rectangular, square, trapezoidal, circular and L-shaped.

19. A system according to claim 10, wherein the angle of the sensor is varied during testing so as to enable an accurate determination of the two-dimensional magnetic map.

20. A system according to claim 10, wherein the surface of the sensor arranged in use to engage with the recording head under test is textured or otherwise arranged so not to stick to the recording head during a test.

21. A system according to claim 10, wherein the sensor is provided with one or more alignment features to enable alignment between the sensor and a recording head under test.

22. A method of making a hard disk drive, the method comprising:
providing a recording head for a hard disk drive; and,
scanning the recording head during manufacture using a method according to claim 1.
